(19) United States
(12) Patent Application Publication
(10) Pub. No.: US 2008/0280657 A1
(43) Pub. Date: Nov. 13, 2008

(54) Seal and actuator assembly

(75) Inventors: Jani C. Maenpaa, Helsinki (FI); Petteri Kauhanen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/801,381

(22) Filed: May 9, 2007

(51) Int. Cl. H04M 1/00; G06F 3/041

(52) U.S. Cl. 455/575.1; 345/173

(57) ABSTRACT

A user interface seal and actuator assembly including an electrical feedback actuator adapted to provide movement when energized; and an overmolded seal. The overmolded seal is overmolded on the feedback actuator to form an overmolded sealing engagement and attachment with the feedback actuator. The assembly is adapted to provide a seal between two components of a user interface. The feedback actuator is adapted to move a first one of the components relative to a second one of the components.

### BACKGROUND OF THE INVENTION

1. Field of the Invention

The invention relates to a seal and actuator assembly and, more particularly, to a seal and actuator assembly for a user interface (UI).

2. Brief Description of Prior Developments

User interfaces for mobile device have included touch screen and touch panel technologies in the past. These user interfaces do not have the same user tactile feedback as traditional mechanical keys. A traditional mechanical key can provide the user with a strong force feedback when a button is pressed. Thus, controlling the device with a “dead” surfaces, such as touch screens and touch panels, can be frustrating to the user when compared to a traditional mechanical key tactile feedback.

U.S. Patent Application Publication No. 2001/0035854 A1 discloses use of haptic feedback for touchpads and other touch controls. Haptics with physical feedback have been studied and implemented in high end gaming devices, virtual hand 3D modeling software, and automotive industry and remote control devices for the home (e.g. Sony NAVITUS™).

Tactile cues of pressing the keys have been implemented with domes or in the case of virtual keys on a touch screen with sound and graphical cues. Sony NAVITUS™ has used a piezo element to move the touch screen to give a tactile cue. This, however, has only been a single pulse. Sony introduced a tactile touch panel a few of years ago where the actuator is fixed to move the panel in XY-plane or in Z-axis direction. The panel is fixed to the surrounding mechanics with 4 PORON pads in each panel corner. A continuous sealing cannot be used because the actuator force would not be enough to provide a sensation which could be reliably felt by a user. For this reason, the Sony implementation is used in limited products, such as remote controls that are not subjected to as severe circumstances as mobile phones.

A Japanese company SMK also has a touch panel concept based on a piezo actuator. In the SMK device, a piezo actuator is tightly glued on the touch panel glass. The feedback is given by deforming the glass with the actuator. The integration to surrounding mechanics is also done with four PORON pads in each panel corners.

U.S. patent publication No. 2006/0022952 A1 discloses an electrostrictive polymer as a combined haptic seal actuator.

There is a desire for providing a mechanical integration of a seal with a feedback actuator, for use in a user interface for example, which can be relatively easy and inexpensive to manufacture.

### SUMMARY OF THE INVENTION

In accordance with one aspect of the invention, a user interface seal and actuator assembly is provided including an electrical feedback actuator adapted to provide movement when energized; and an overmolded seal. The overmolded seal is overmolded on the feedback actuator to form an overmolded sealing engagement and attachment with the feedback actuator. The assembly is adapted to provide a seal between two components of a user interface. The feedback actuator is adapted to move a first one of the components relative to a second one of the components.

In accordance with another aspect of the invention, a user interface seal and actuator assembly is provided comprising an electrical feedback actuator adapted to provide movement when energized; and a seal having a pocket. The feedback actuator is mounted inside the pocket. The assembly is adapted to provide a seal between two components of a user interface. The feedback actuator is adapted to move a first one of the components relative to a second one of the components.

In accordance with another aspect of the invention, a method of assembling a user interface is provided comprising overmolding a seal onto a feedback actuator to form an assembly; and connecting the assembly between two components of the user interface to provide a seal between the two components. The feedback actuator is located between the two components such that the feedback actuator can provide relative movement between the two components.

### BRIEF DESCRIPTION OF THE DRAWINGS

The foregoing aspects and other features of the invention are explained in the following description, taken in connection with the accompanying drawings, wherein:

FIG. 1 is a front view of a portable hand-held electronic device comprising features of the invention;

FIG. 2 is a partial cross sectional view of some of the components of the device shown in FIG. 1;

FIG. 3 is an enlarged view of some of the components of the device shown in FIG. 1;

FIG. 4 is an exploded perspective view of a cover member of the device shown in FIG. 1 and a user interface subassembly;

FIG. 5 is a perspective view of the user interface subassembly shown in FIG. 4;

FIG. 6 is an enlarged schematic cross sectional view of some of the components shown in FIG. 2;

FIG. 7 is an exploded perspective view of some of the components of the user interface subassembly shown in FIG. 5;

FIG. 8 is a perspective view of the components shown in FIG. 7 in an assembled position;

FIGS. 9-11 are perspective views of mold dies of a molding apparatus used to mold the seal of the user interface subassembly shown in FIG. 5, and showing positioning of other components in the molding apparatus;

FIG. 12 is a perspective view of the cover member and the user interface subassembly shown in FIG. 4 which are shown in an assembled position;

FIG. 13 is a schematic diagram illustrating the use of the user interface subassembly in various different devices; and

FIG. 14 is a diagram illustrating an example of one method of the invention.

### DETAILED DESCRIPTION OF THE PREFERRED EMBODIMENT

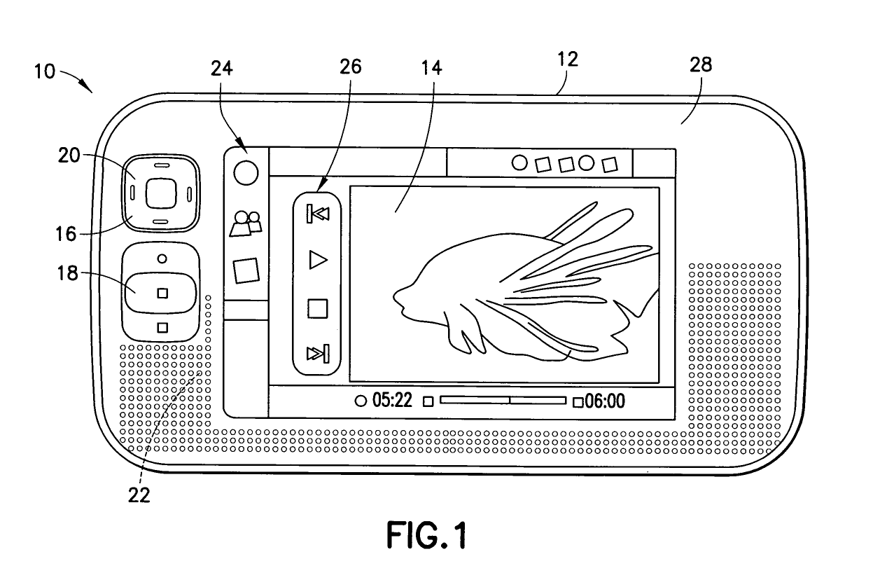

Referring to FIG. 1, there is shown a front view of a hand-held portable electronic device 10 incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

The device 10, in the embodiment shown, generally comprises a housing 12, a display 14, a user input section 16 having a key 18 and a five-way key pad 20, and electronic circuitry 22 located inside the housing. The electronic circuitry 22 is operably connected to the input section 16 and the display 14. The electronic circuitry 22 generally comprises a controller, a memory and other electronic circuitry and components suitable for various applications.

The device 10, in this embodiment, is adapted to provide a mobile telephone application, a camera application, a music player application, a gaming application, and an Internet browser application. In alternate embodiments, more or less applications could be provided. With these applications the electronic circuitry includes a transceiver and a camera. In alternate embodiments, additional or alternative components could be provided. The electronic components could also comprise an infra red LED such that the device could be used as a remote control for another device such as a television, or television set-top box, or DVR for example. In the view shown in FIG. 1, the device is using a camera viewer application with the display 14 being used to view and control viewing of digital picture imagery on the display.

The display 14 is a touch screen. However, features of the invention could be used in a touch panel which does not have an actively changeable display screen. The display 14 is able to display various application displays and information of the touch screen including, for example, digital pictures, Internet web site pages, application control screen and menus. These are only some examples and should not be considered as limiting.

In addition to being able to function as a display screen, the display 14 is also adapted to sense touch or depression of the display by a user's finger or a stylus. For example, in the embodiment shown in FIG. 1, the display screen shows application selection icons 24 and application control icons 26. With the four application selection icons 24 shown by depressing the display 14 at one of the icons, the user can select a web browser icon, a communications icon, a file explorer icon, or a music player icon (the picture viewer application already running on the display). By depressing the display 14 at one of the icons 24, by the user pressing against the display 14, the device 10 can switch to that selected application. With the picture viewer application running as shown in FIG. 1, the application control icons 26 comprise four picture viewer icons including a play icon, a stop icon, a fast forward icon and a fast reverse icon. Thus, by depressing one of the icons 26, by the user pressing against the display 14, the device 10 can perform that function with the picture viewer application. It should be noted that these are only examples and should not be considered as limiting. Additional and/or alternative application icons can be provided. Each application can have its own application control icons specific to that application.

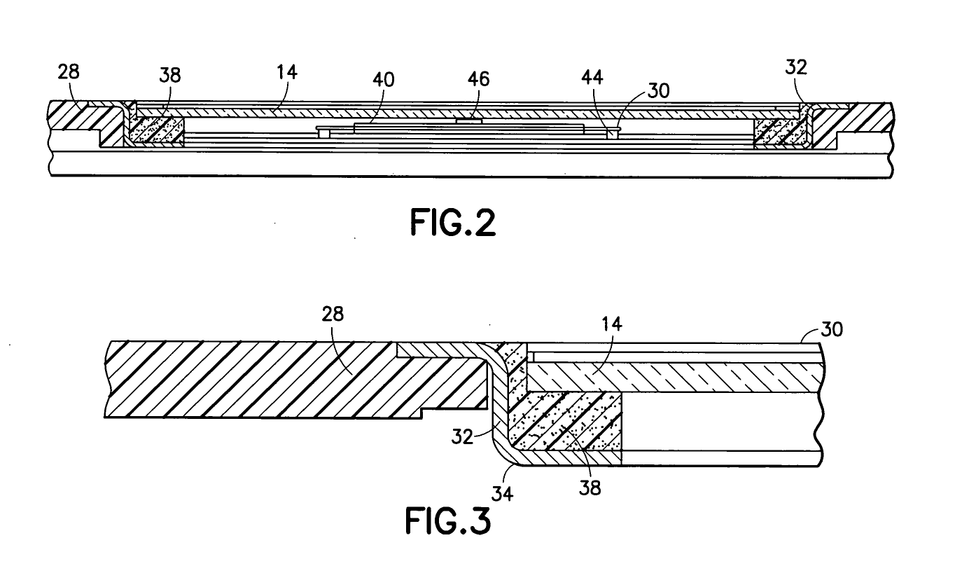

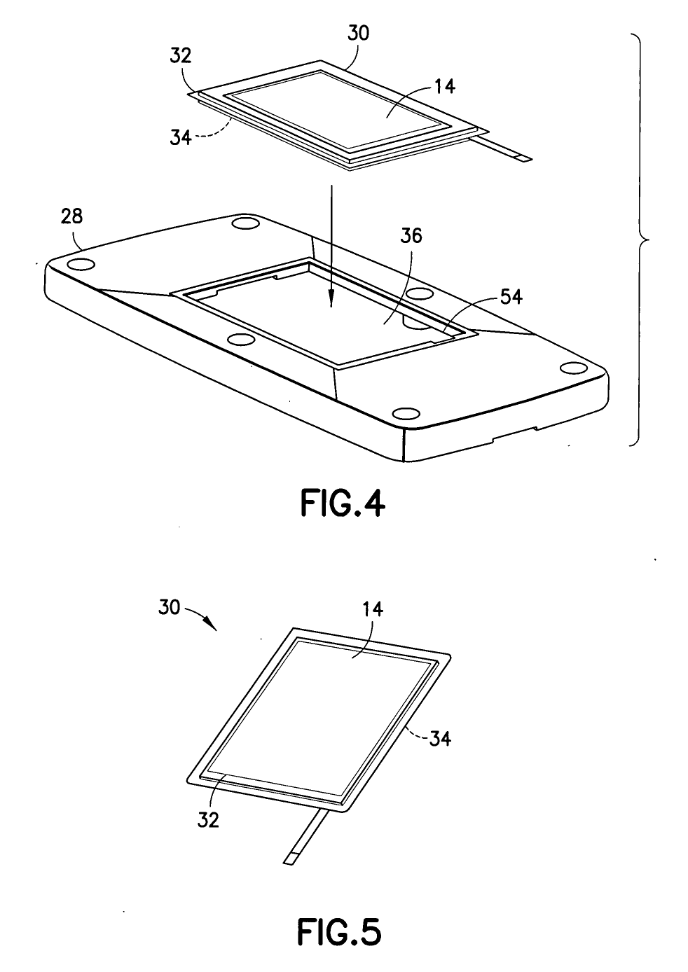

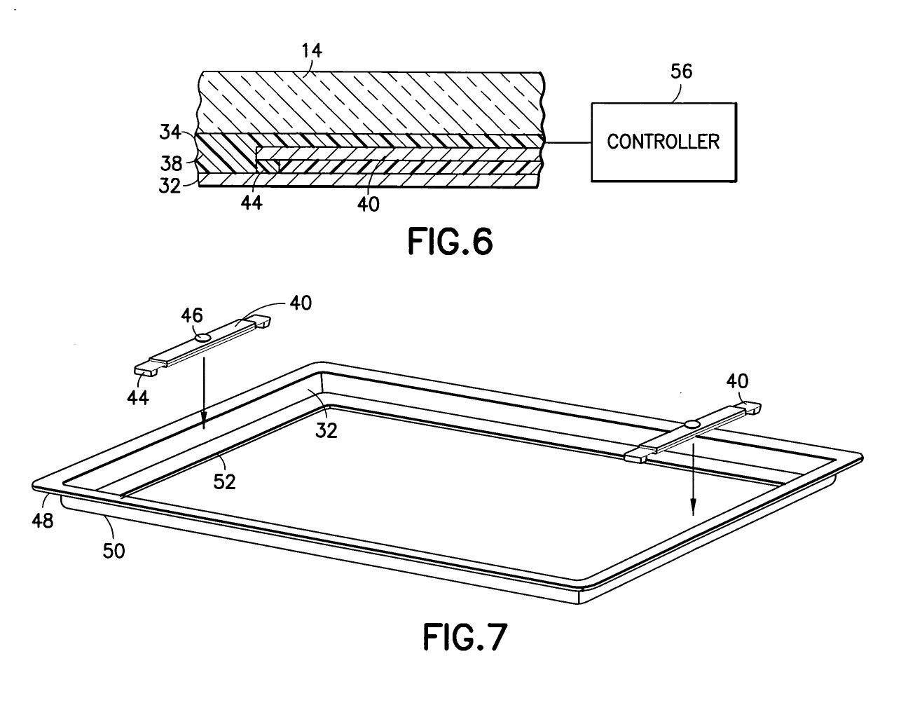

Referring also to FIGS. 2 and 3, the display 14 is part of a user interface subassembly 30 (see FIGS. 4 and 5) which comprises a subassembly frame 32 and a user interface seal and actuator assembly 34. The user interface subassembly 30 is connected to a cover member 28 of the housing 12 in an aperture 36 (see FIG. 4) of the cover member 28. Referring also to FIG. 6, the seal and actuator assembly 34 generally comprises a seal 38 and two feedback actuators 40. In alternate embodiments, more or less than two feedback actuators could be provided.

The seal 38 is comprised of an elastic, resilient material such as molded polymer material. The seal 38 has a general rectangular ring shape. However, in alternate embodiments other shapes could be provided. The seal 38 has pockets 42 which the feedback actuators 40 are located in. In this embodiment the assembly has supports 44 which support opposite ends of each feedback actuator 40 on the frame 32, and a center support 46 which contacts the underside of the display 14. Otherwise, material of the seal 38 is located on the top and bottom sides of the feedback actuators 40 between the display 14 and the frame 32. However, in alternate embodiments one or more of the supports 44, 46 might not be provided; such as when the thickness of the seal between the actuator and the display and/or frame is very small.

Referring also to FIG. 7, the frame 32 has a general rectangular ring shape. However, in alternate embodiments any suitable shape could be provided. The frame 32 is preferably comprised of metal, but could be comprised of alternative material(s). The frame 32 has a top lip 48, an inner side wall 50, and a bottom lip 52. The top lip 48 projects outwardly. The bottom lip 52 projects inwardly. The bottom lip 52 supports the assembly 34 thereon. The top lip 48 supports the subassembly 30 on the rim 54 of the aperture 36 of the cover member 28 (see FIG. 4).

The feedback actuators 40 are preferably piezo electric actuators. However, in alternate embodiments the feedback actuators 40 could comprise any suitable type of feedback actuators including, for example, linear or rotary electromagnetic actuators or vibrators. As shown in FIG. 6, the actuators 40 are operably connected to a controller 56 of the electronic circuitry 22. The controller 56 is adapted to energize or actuate the actuators 40 to impart a movement force to the display 14. This can be used to deliver tactile feedback to the user when the user depresses the display screen, such as when the user depresses the display 14 at one of the icons 26 and/or 24 for example. This can provide a haptic feedback to the user when the user actuates the touch selection feature of the touch screen display. In alternate embodiments this could be expanded to other types of feedback including gaming or music playing for example. As an alternative or additional use, the motion imparted by the actuators might not be feedback, but could instead be a tactile signaling not representative of feedback.

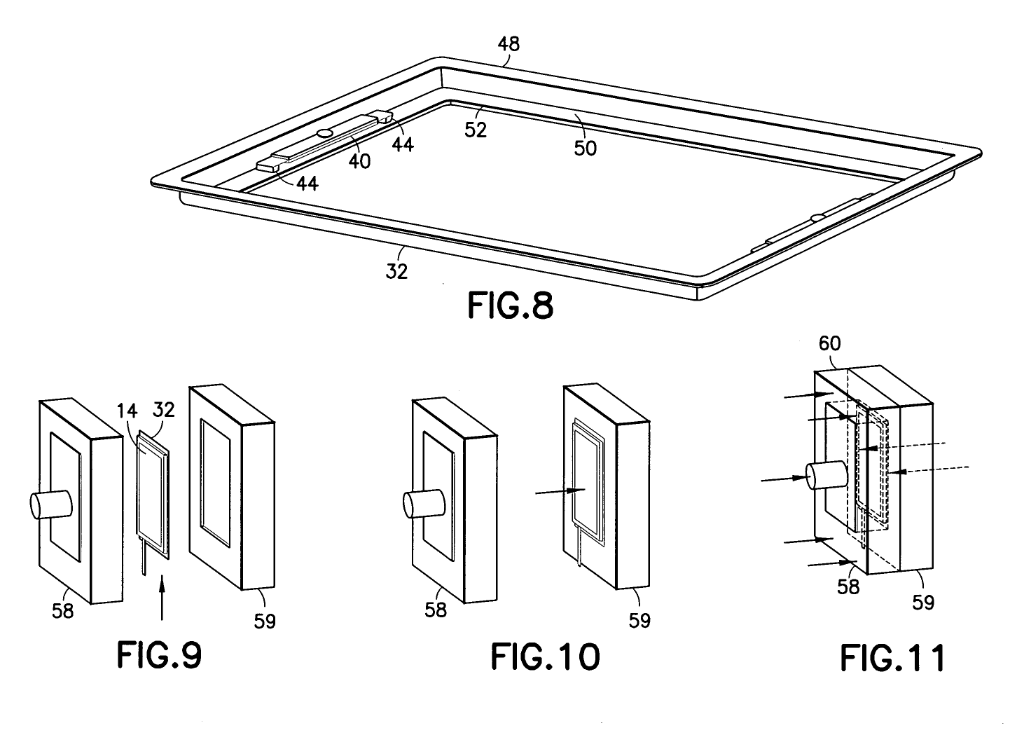

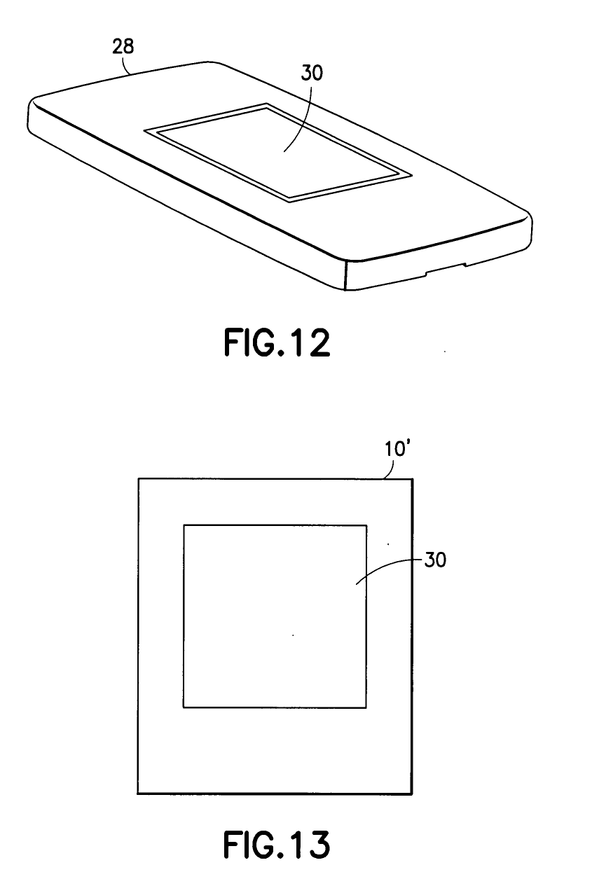

Referring also to FIGS. 7-11, one method of forming the seal and actuator assembly 34 will be described. In this method, the actuators 40 are positioned on the frame 32 as shown in FIGS. 7 and 8. The end supports 44 are placed against the top side of the bottom lip 52. The display 14 is placed against the center supports 46 and the components are placed between mold dies 58, 59 of a molding apparatus 60. The molding apparatus is closed as shown in FIG. 11 and the material to form the seal 38 is injected between the mold dies 58, 59. This overmolds the seal 38 onto the actuators 40. The overmolded seal 38 surrounds and seals the feedback actuators 40. Thus, the assembly 30 is provided as actuators with an overmolded seal. The overmolding process, in this example, also results in the subassembly 30 being formed with an overmolded seal 38 on the display 14 and the frame 32. The assembly 30 can then be mounted in the aperture 36 of the cover member 28 as shown in FIG. 4 to produce the device subassembly shown in FIG. 12.

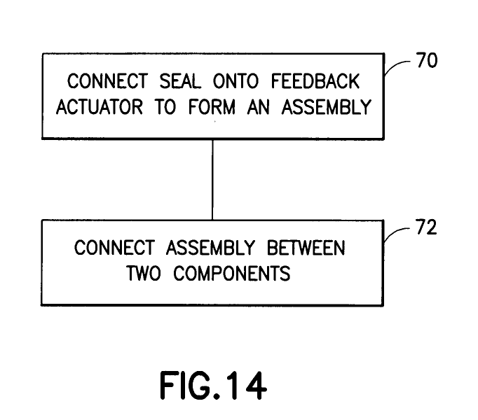

The example described above is merely an example. The seal and actuator assembly 34 could be formed separate from the display 14 and frame 32, and then subsequently attached to the display and frame. In another example, the seal 38 might not be an overmolded seal. Instead, the seal 38 could be formed with pockets which the actuators 40 are subsequently inserted into. As shown in FIG. 14, the method can comprise connecting a seal onto a feedback actuator to form an assembly as indicated by block 70, and connecting the assembly between two components as indicated by block 72. In one type of method, connecting the seal onto the feedback actuator can comprise overmolding. In one type of method, connecting the assembly between two components can comprise overmolding the seal onto the feedback actuator while also overmolding the seal onto a frame as a first one of the components and onto a display panel as a second one of the components.

With the invention, a touch screen/panel can be fixed to the surrounding mechanics, e.g. a mobile telephone A-cover, with an elastic material such as a resilient gel-like material. The gel can seal the seam between the A-cover and the touch screen/panel. The piezo actuators can be buried inside this gel, in order to provide the actuator proper moisture and mechanical shock shielding.

The seal can be molded in an injection mold by use of an elastic material on/between a touch window and a metal frame; to both seal and join the members together during the injection molding process. The piezo actuators can be located inside the elastic material. Thus, all four components (touch window/panel, a metal frame, actuator(s), and seal) are assembled at the same time and now the touch window module which is ready to be assembled with the main assembly of the device.

The gel/seal provides good adhesion and elastic fixing of the touch screen/panel to surrounding mechanics. This enables product designs where the surfaces of the touch screen/panel and the A-cover are in the same level. The gel/seal provides continuous dust and moisture shield without damping the tactile feedback too much. The gel/seal can also protect the actuator from moisture and mechanical shocks.

With the invention, touch screens and touch panels can be “brought to life” by actuating them with different motors/actuators. By vibrating the user interface surface only a few microns with certain pulse trains, a sensation similar to a mechanical button can be provided. Tactile feedback can be provided with different electromagnetic linear or rotational vibrators. In addition or alternatively, piezo electric actuators can be used. When compared to vibrator motors, piezo actuators provide very sharp pulses because of their fast response times. Thus, piezos are a preferred technology in high end devices; where the feedback pulse should be given at the same instant as the user touches the user interface. Additionally, with piezos the pulse shape can be more versatile, whereas vibrators can only provide a single button-click like feedback.

With the invention, mechanical integration of components can be provided. Because of the compact size and low operation voltage requirement, the generated force of piezo electric actuators is very limited. A piezo actuator can move easily even a large display module or a touch panel, when they are freely floating or very lightly coupled to the a cover, etc. surrounding mechanics. However, in real life there has to be proper dust/moisture shielding between these components. This is traditionally done with PORON (or similar) foam gaskets that encircle continuously display/panel outlines. This setup is often too rigid, and the movement provided by the piezo would be totally damped (i.e., there is no perceptible tactile feedback). Thereby, a more energy efficient integration of display/touch panel to the surrounding mechanics needed to be found. Additionally, piezo actuators are typically sensitive to environmental effects, such as moisture and mechanical shocks. Actuator should be sealed from moisture and mechanical shocks. The invention provides solutions to these problems. The invention can provide both sealing and good force delivery from a feedback actuator without excessive dampening.

Referring also to FIG. 13, the user interface subassembly 30 is shown as part of a device 10′. The device 10′ could be, for example, a telephone, a game player, a digital camera, an internet browser, a PDA, a remote control handset, a bar code scanner, a keypad control (such as for a security door entry for example), or any other electronic device or tool which has a touch pad, touch screen or touch panel.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A user interface seal and actuator assembly comprising:
an electrical feedback actuator adapted to provide movement when energized; and
an overmolded seal which has been overmolded on the feedback actuator to form an overmolded sealing engagement and attachment with the feedback actuator,
wherein the assembly is adapted to provide a seal between two components of a user interface, and wherein the feedback actuator is adapted to move a first one of the components relative to a second one of the components.

2. An assembly as in claim 1 wherein the feedback actuator comprises a piezo-electric actuator.

3. An assembly as in claim 1 wherein the feedback actuator comprises an electromagnetic vibrator.

4. An assembly as in claim 1 wherein the feedback actuator is buried inside the overmolded seal.

5. An assembly as in claim 4 further comprising actuator supports extending from the feedback actuator to an exterior side of the seal.

6. An assembly as in claim 1 wherein the assembly comprises multiple ones of the feedback actuator with the seal overmolded thereon.

7. A user interface subassembly for an electronic device comprising:
a subassembly frame;
a touch display; and
a user interface seal and actuator assembly as in claim 1 located between the subassembly frame and the touch display.

8. A hand-held portable electronic device comprising:
a device frame;
electronic circuitry located inside the frame; and
a user interface subassembly as in claim 7 located in an aperture of the device frame.

9. A hand-held portable electronic device as in claim 8 wherein the device comprises a telephone with a transceiver.

10. A hand-held portable electronic device as in claim 8 wherein the device comprises a game player.

11. A hand-held portable electronic device as in claim 8 wherein the device comprises a music player.

12. A hand-held portable electronic device as in claim 8 wherein the device comprises a digital camera.

13. A hand-held portable electronic device as in claim 8 wherein the device comprises an internet browser.

14. A hand-held portable electronic device as in claim 8 wherein the device comprises a remote control handset.

15. A user interface seal and actuator assembly comprising:
an electrical feedback actuator adapted to provide movement when energized; and
a seal having a pocket, wherein the feedback actuator is mounted inside the pocket,
wherein the assembly is adapted to provide a seal between two components of a user interface, and wherein the feedback actuator is adapted to move a first one of the components relative to a second one of the components.

16. An assembly as in claim 15 wherein the feedback actuator comprises a piezo-electric actuator.

17. An assembly as in claim 15 wherein the feedback actuator comprises an electromagnetic vibrator.

18. An assembly as in claim 15 wherein the seal is an overmolded seal which has been overmolded onto the feedback actuator to form a seal with the feedback actuator.

19. An assembly as in claim 18 wherein the feedback actuator is buried inside the overmolded seal.

20. An assembly as in claim 19 further comprising actuator supports extending from the feedback actuator to an exterior side of the seal.

21. An assembly as in claim 15 wherein the seal has a general ring shape, wherein the seal comprises multiple ones of the pocket located on opposite sides of the general ring shape, and wherein the assembly comprises multiple ones of the feedback actuator located in respective ones of the pockets.

22. A user interface subassembly for an electronic device comprising:
a subassembly frame forming a first one of the components;
a touch display forming a second one of the components; and
a user interface seal and actuator assembly as in claim 15 located between the subassembly frame and the touch display.

23. A hand-held portable electronic device comprising:
a device frame;
electronic circuitry located inside the frame; and
a user interface subassembly as in claim 22 located in an aperture of the device frame.

24. A method of assembling a user interface comprising:
overmolding a seal onto a feedback actuator to form an assembly; and
connecting the assembly between two components of the user interface to provide a seal between -the two components, wherein the feedback actuator is located between the two components such that the feedback actuator can provide relative movement between the two components.

25. A method as in claim 24 wherein overmolding the seal comprises overmolding the seal onto the feedback actuator while also overmolding the seal onto a frame as a first one of the components and onto a display panel as a second one of the components.
